(19) United States
(12) Patent Application Publication
(10) Pub. No.: US 2009/0301042 A1
(43) Pub. Date: Dec. 10, 2009

(54) GRADIENT DENSITY ENGINE INTAKE FILTER MEDIA

(75) Inventor: Ron TROXELL, Forest Park, IL (US)

Correspondence Address: ORUM & ROTH LLC, 53 W. JACKSON BLVD., SUITE 1616, CHICAGO, IL, 60604, US

(73) Assignee: R2C PERFORMANCE PRODUCTS LLC, Forest Park, IL (US)

(21) Appl. No.: 12/477,603

(22) Filed: Jun. 3, 2009

Related U.S. Application Data
(60) Provisional application No. 61/058,808, filed on Jun. 4, 2008.

(51) Int. Cl. B01D 50/00

(52) U.S. Cl. 55/330; 55/329

(57) ABSTRACT

A filter for internal combustion engine air intake comprised of a synthetic fiber media uniquely enhanced with a gradient density configuration. The media described in this application is a low restriction synthetic fiber media enhanced with gradient density configuration to greatly improve efficiency and dust holding capacity. The invention is for use and configuration for use in engine intake air filtration.

### BACKGROUND OF THE INVENTION

1. Field of the Invention

A filter for internal combustion engine air intake comprised of a synthetic fiber media uniquely enhanced by virtue of its gradient density characteristics.

The ideal filter media would be one that has a very high initial efficiency, very low restriction to flow and a high dust holding capacity for long service life.

2. Summary of the Prior Art

Common engine air filters are typically constructed of cellulose fiber or synthetic fiber based media, with cellulose media typically having higher restriction to flow and lower dust holding capacity but having higher cleaning efficiency. Synthetic fiber media is often constructed to have lower restriction to flow but can hold more contaminant before becoming restrictive but at a lower cleaning efficiency.

Either of these media can be configured to improve any one of their performance characteristics but always at the expense of some other performance area. Spreading the fibers can reduce restriction but it also reduces efficiency. Using finer fibers closer together can increase efficiency without excessive increases in restriction but the dust holding capacity decreases dramatically.

All standard, non-enhanced media efficiencies begin at their lowest levels when they are new and clean (commonly referred to as initial efficiency) and then will gain efficiency as they accumulate dust. These collected dust particles actually form a barrier on the surface of the filter fibers but until those particles form on the filter the media performs poorly.

### SUMMARY OF THE INVENTION

The media described in this application is a low restriction synthetic fiber media enhanced by a gradient density configuration to greatly improve efficiency and dust holding capacity.

The media is nonwoven. It has a progressively finer/higher fiber density starting from the outside dirt air side moving in toward the clean air side. The target dust can penetrate deeply into the media using more than simply the upstream surface area to be captured by the media. The depth loading of the media is greatly enhanced.

This invention is for its use and configuration for use in engine intake air filtration.

### DETAILED DESCRIPTION OF THE INVENTION

This gradient density engine air filter is a new innovative concept which provides the most effective solution in filtering particulates down to 0.05 microns in size.

Typical filter media used to remove particles at this smallest size fraction require the use of extremely fine fibers. These materials, whilst often achieving high efficiencies, are usually associated with the inherent disadvantages of low dust holding capacity and high resistance to air flow.

The gradient density configuration which give the benefit of a high dust loading capacity, low air flow resistance and high efficiencies against sub-micron particles.

This new gradient density filter offers flexibility to fabricators whilst meeting their specific filtration requirements. It is this flexibility that allows lamination to a variety of different substrates. This imparts additional properties such as palatability, odor removal and mouldability.

This new filter media can be supplied in rolled, sheet, cut pad or pleated forms.

A high efficiency low restriction filter media for use as an engine intake air filter is disclosed. The media is comprised of synthetic fibers, primarily polyester, with the fiber density increasing in progression from the air entering side to the air leaving side of the media. Fibers are thermally bonded to create a fiber matrix of high strength and high air permeability capable of high particle removal efficiency and dust holding capacity.

Drawing FIG. 3 illustrates a gradient density embodiment where the density gradients are somewhat discrete. In other embodiments, the density gradients vary in a non-discrete, uniform manner.

The media as disclosed has a weight of approximately 230 grams per meter squared, a thickness in the direction of flow of approximately 3.0 millimeters and an air permeability of approximately 1,100 liters per square meter per second at a restriction of two millibars.

A typical filtration media of similar physical construction when tested using the ISO 5011 testing protocol and fine test dust as the challenge particulate at a media velocity between 60 to 80 feet per minute will achieve an initial collection efficiency of less than 90 percent, and a cumulative efficiency of less than 95 percent with a dust holding capacity of less than 150 grams.

The inventive media at these conditions will achieve an initial efficiency greater than 98 percent, a cumulative efficiency greater than 99 percent, and a dust holding capacity greater than 300 grams.

Having thermally bonded fibers creates a semi-rigid media so when configured in a pleated configuration as typically constructed, no additional supporting screen needs to be co-pleated with the media to support the pleated structure. The omission of the co-pleated screen reduces restriction through the media and reduces cost of fabrication.

The inventive media supports the acoustic behavior of an engine air duct, provides high thermal and mechanical stability, especially under pulsating forces. Additionally, good elasticity in crash tests is exhibited.

This new media is resistant to water, engine oils, fuel fumes, and chemicals, and shows a high aging resistance. The progressive gradient structure can be enhanced by a microfiber barrier layer on the downstream side. This results in higher dust collection efficiency rates, especially useful in turbo diesel engines and other engines having high airflow rates.

The fiber structure is mechanically and thermally bonded. Stiffening treatments are unnecessary. The media satisfies the flame retardant class F1 according to DIN53438.

The media is a depth loading filter as compared to surface loading filter such as cellulose paper. In the present invention, the majority of dust is trapped in the depth of the media, fine particles penetrating deeper into the media and coarse particles collected closer to the upstream side. This selective distribution of dust particles in the media maintains a high air permeability which optimizes pressure drop problems for the lifetime of the filter. Prior art paper filters collect dust particles on the upstream side with little penetration into the media. This builds up a dust layer on the upstream side creating faster pressure drop.

With the present invention, the filter element can be reduced to one-third to one-quarter of the size of a comparable cellulose paper filter. The filter element weight can also be decreased by 20 to 40 percent.

In a test subjecting filters to water, the inventive media showed no change in shape or tensile strength after 72 hours under wet conditions, but the paper media showed a 70% decrease in tensile strength.

The inventive media overcomes the deficiencies of cellulose paper because of its irreversibly thermally bonded structure. No dust breaks through on the downstream side during engine pulsation. This improved performance is due to the strong density of the downstream side of this new media.

An additional benefit is that in one embodiment a single polymer fiber is used, so the filter is environmentally friendly and easily disposed.

It can be any thickness, however current technology requires thickness of approximately 0.060″-0.100″ to be suitable for engine intake air filtration. The current product in development uses approximately 0.080″ thick material.

It is not necessary to co-pleat the media. However, an outside and/or inside mesh be utilized. A new and inventive hexagonal shaped mesh material may be employed. The hexagonal shape allows for an improvement in open area from 60% for round, perforated mesh to 80% for new hexagonal mesh.

However, the media may be co-pleated with aluminum wire mesh support on both sides in a variety of pleat heights. Wire mesh is used to support media, however other methods may be employed such as a pleatable plastic mesh laminate backing.

The filter configuration may be cylindrical, oval, frustro-conical, or flat panels in any aspect ratio. Media may be potted into molded endcaps that also comprises of the filter seal, utilizing a resin material such as polyurethane or a plastisol. Or it may be potted with a similar resin material into an end cap composed of any type of metal or composite using a separate gasket material to create a positive seal. The filter is designed to be cleanable with a compressed air nozzle utilizing shop air blown from the downstream side of the media out toward the upstream side and then reused with minimal loss of performance.

The invention integrates this type of filter media into engine air filters, particularly automotive air filtration.

Table 1

The following are some tables illustrating characteristics of the invention:

| | Inventive | | |
|---|---|---|---|
| Media | Nonwoven | | |
| Characteristics | Material | Cellulose Paper | Multilayer Foam |
| Thickness | 3.0 | Less than 1.0 | Greater than 10 |
| (millimeters) | | | |
| Weight (g/m²) | 230-250 | 100-120 | 100-200 |
| SAE Coarse | 900-1300 | 190-300 | 250-350 |
| Holding Capacity | | | |

TABLE 2
CONSTRUCTION

| Fiber | Treatment | Weight |
|---|---|---|
| Polyester | thermally bonded | app. 230 g/m² |

TECHNICAL DATA

| Parameter | Value | |
|---|---|---|
| Weight | 230 +/− 25 | g/m² |
| Thickness | 3.0 +/− 0.3 | mm |
| Air Permeability at 2 mbar | 1100 +/− 100 | l/m²s |

TABLE 3
The Invention

| CFM | D.P. | Dust Feed | Minutes |
|---|---|---|---|
| 400 | 7.8 | 0 | 0 |
| 400 | 7.9 | 11.33 | 1 |
| 400 | 8 | 22.66 | 2 |
| 400 | 8.1 | 33.99 | 3 |
| 400 | 8.2 | 45.32 | 4 |
| 400 | 8.3 | 56.65 | 5 |
| 400 | 8.5 | 67.98 | 6 |
| 400 | 8.7 | 79.31 | 7 |
| 400 | 8.9 | 90.64 | 8 |
| 400 | 9.2 | 101.97 | 9 |
| 400 | 9.5 | 113.3 | 10 |
| 400 | 9.7 | 124.63 | 11 |
| 400 | 10 | 135.96 | 12 |
| 400 | 10.35 | 147.29 | 13 |
| 400 | 10.6 | 158.62 | 14 |
| 400 | 11 | 169.95 | 15 |
| 400 | 11.45 | 181.28 | 16 |
| 400 | 11.75 | 192.61 | 17 |
| 400 | 12.25 | 203.94 | 18 |
| 400 | 12.7 | 215.27 | 19 |
| 400 | 13.1 | 226.6 | 20 |
| 400 | 13.55 | 237.93 | 21 |
| 400 | 13.9 | 249.26 | 22 |
| 400 | 14.4 | 260.59 | 23 |
| 400 | 14.9 | 271.92 | 24 |
| 400 | 15.5 | 283.25 | 25 |
| 400 | 16.2 | 294.58 | 26 |
| 400 | 16.75 | 305.91 | 27 |
| 400 | 17.2 | 317.24 | 28 |
| 400 | 17.7 | 328.57 | 29 |
| 400 | | | 30 |

Terminate @ (Initial D.P. + 10) = 17.8 w.g.

20 g fed at 1:45 elapsed:

| | |
|---|---|
| ABS Filter | 137.36 |
| GAIN | 0.18 |

| | ABS Filter | Element | Total Fed |
|---|---|---|---|
| After | 138.2 | 1077 | |
| Before | 137.18 | 754 | |
| GAIN | 1.02 | 323 | 324.02 |

Initial Efficiency (1 − (A/20)) × 100
99.1
Cumulative Efficiency (1 − (B/D)) × 100
99.7
Dust Holding Capacity (C)
323

TABLE 4
Cellulose

| CFM | D.P. | Dust Feed | Minutes |
|---|---|---|---|
| 400 | 7.8 | 0 | 0 |
| 400 | 8.4 | 9.81 | 1 |
| 400 | 9.4 | 19.62 | 2 |
| 400 | 10.6 | 29.43 | 3 |
| 400 | 11.9 | 39.24 | 4 |
| 400 | 13.2 | 49.05 | 5 |
| 400 | 14.8 | 58.86 | 6 |
| 400 | 15.9 | 68.67 | 7 |
| 400 | 17.3 | 78.48 | 8 |
| 400 | 17.8 | 82 | 8.4 |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |

Terminate @ (Initial D.P. + 10) = 17.8 w.g.

20 g fed at 1:45 elapsed:

| | |
|---|---|
| ABS Filter | 52.03 |
| GAIN | 0.34 |

| | ABS Filter | Element | Total Fed |
|---|---|---|---|
| After | 52.09 | 885 | |
| Before | 51.69 | 803 | |
| GAIN | .4 | 82 | 82.4 |

Initial Efficiency (1 − (A/20)) × 100
98.5
Cumulative Efficiency (1 − (B/D)) × 100
99.5
Dust Holding Capacity (C)
82

TABLE 5
COTTON GAUZE

| CFM | D.P. | Dust Feed | Minutes |
|---|---|---|---|
| 400 | 7.3 | 0 | 0 |
| 400 | 7.3 | 11.33 | 1 |
| 400 | 7.4 | 22.66 | 2 |
| 400 | 7.4 | 33.99 | 3 |
| 400 | 7.6 | 45.32 | 4 |
| 400 | 7.8 | 56.65 | 5 |
| 400 | 8 | 67.98 | 6 |
| 400 | 8.2 | 79.31 | 7 |
| 400 | 8.8 | 90.64 | 8 |
| 400 | 10.2 | 101.97 | 9 |
| 400 | 11.5 | 113.3 | 10 |
| 400 | 13.3 | 124.63 | 11 |
| 400 | 18.1 | 146.4 | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |
| 400 | | | |

Terminate @ (Initial D.P. + 10) = 17.3 w.g.

20 g fed at 1:45 elapsed:

| | |
|---|---|
| ABS Filter | 54 |
| GAIN | 2.09 |

| | ABS Filter | Element | Total Fed |
|---|---|---|---|
| After | 58.31 | 757 | |
| Before | 51.91 | 617 | |
| GAIN | 6.4 | 140 | 146.4 |

Initial Efficiency (1 − (A/20)) × 100
90.8
Cumulative Efficiency (1 − (B/D)) × 100
95.6
Dust Holding Capacity (C)
140

### BRIEF DESCRIPTION OF THE FIGURES

FIG. 1. A Graph of Restriction Versus Dust Fed

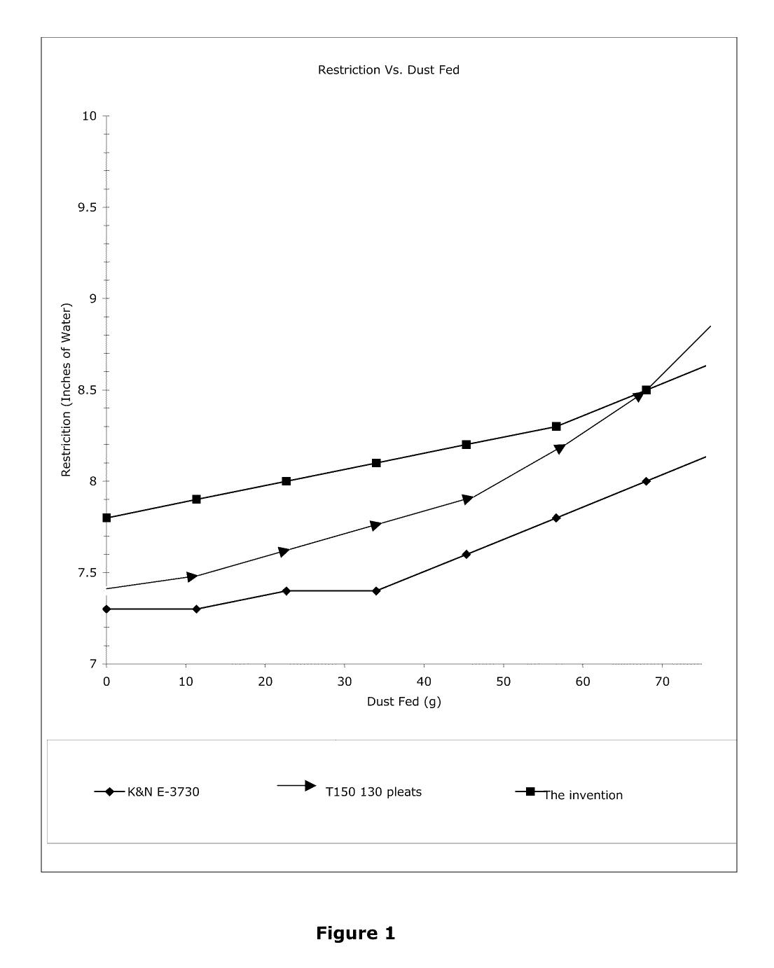

FIG. 2. Airflow resistance

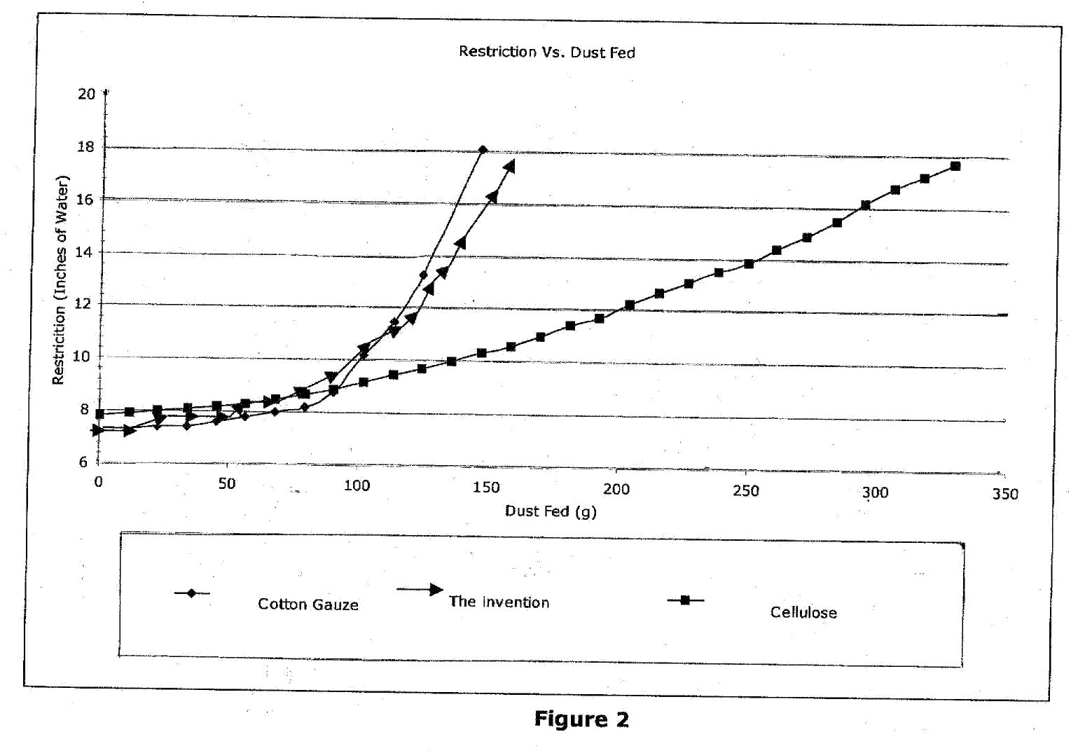

Airflow resistance for Technostat weights from 50 to 500 g/m² against media velocities from 0.05 to 0.3 m/sec.

FIG. 3. Gradient Density Engine Intake Filter.

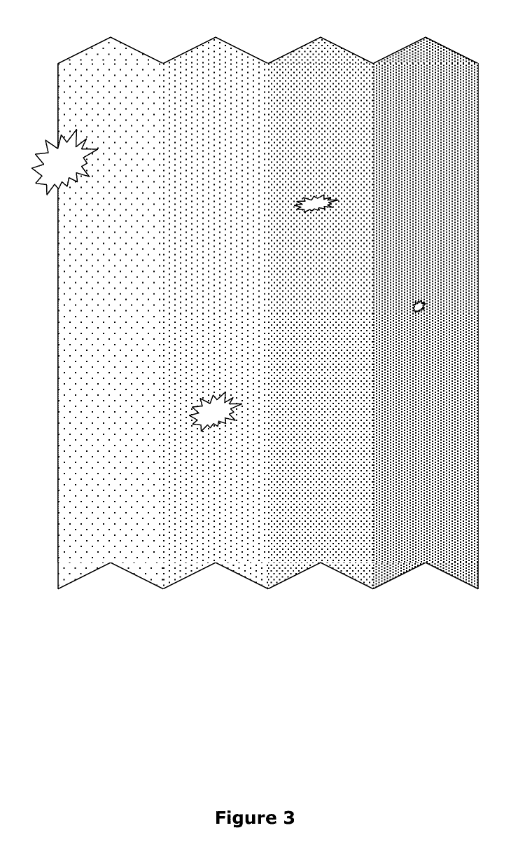

FIG. 4. Top View of Filter.

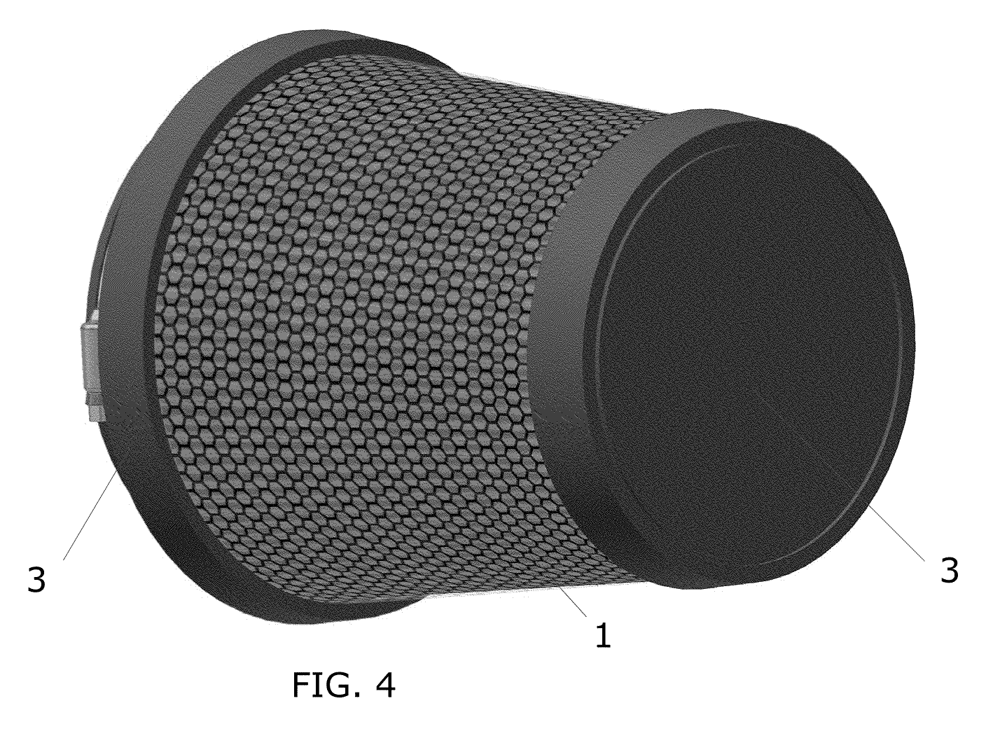

FIG. 5. Outlet View of Filter.

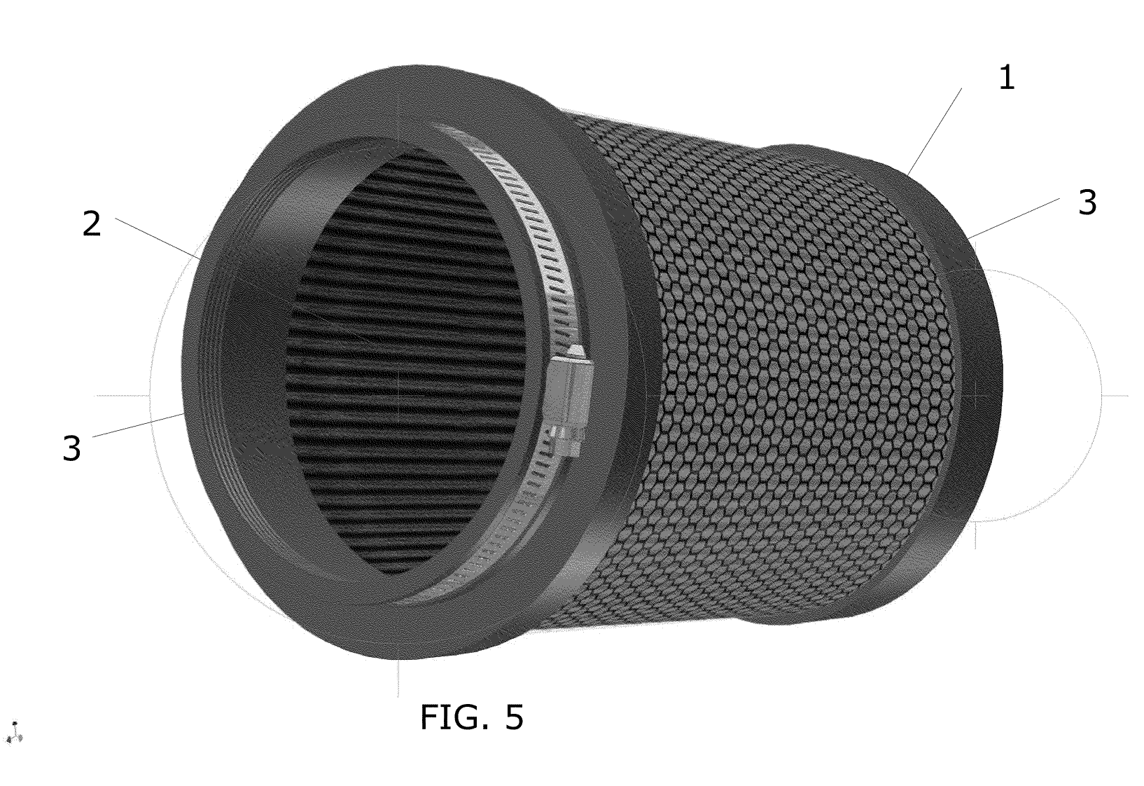

FIG. 6. Side View of hexagonal support mesh.

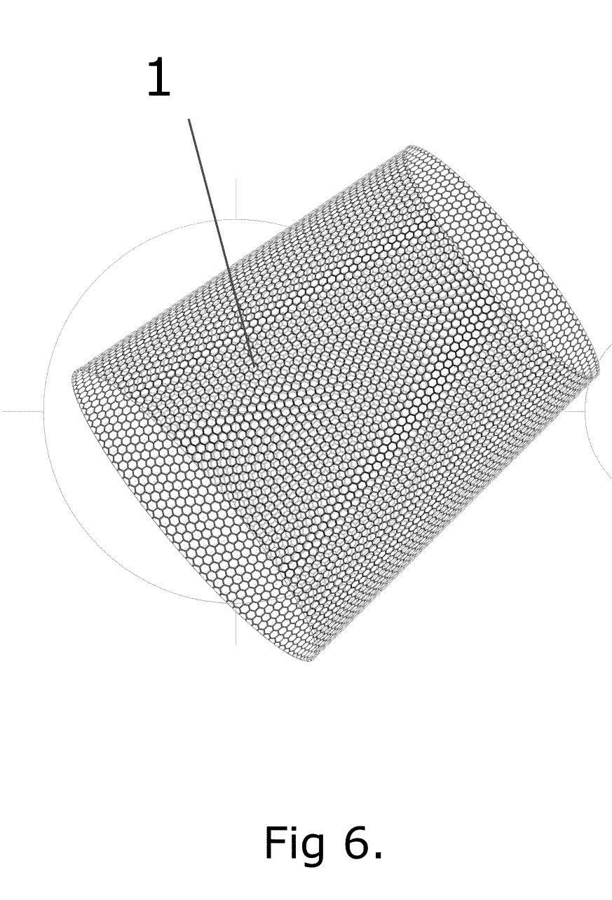

1. An air filter for an internal combustion engine, comprising:
A filter media,
At least one engine air intake edge seal,
Said edge seal being bonded to an edge of said filter media and being mateable with an engine air intake structure of an internal combustion such that substantially all combustion air drawn through the engine air intake structure passes through the filter media,
Said filter media being a non-woven synthetic fiber material,
Said fiber material having fibers being thermally bonded to each other to form a filter material having an overall rigidity sufficient to retain its initial shape in the path of volume and velocity intake air flows common to internal combustion engine,
Said filter media and fiber material having an upstream air impingement surface and a downstream air exiting surface,
Porosity of said filter media and fiber material decreasing from the upstream air impingement surface to the downstream air exiting surface,
Rigidity of said filter media and fiber material increasing from the upstream air impingement surface to the downstream air exiting surface,
Wherein said filter media traps filtered particles entrained in an intake air flow such that larger filtered particles are trapped at or near the upstream air impingement surface and progressively smaller filtered particles are trapped at positions in the filter media progressively closer to the downstream air exiting surface,
The resulting air filter exhibiting favorable depth loading, lifetime filtering efficiency, and air flow characteristics.

2. An air filter for an internal combustion engine according to claim 1, wherein said filter media comprises primarily polyester.

3. An air filter for an internal combustion engine according to claim 2, wherein said filter media has a weight distribution of 220-240 grams per square meter, air permeability of 1000-1200 liters per square meter per second at a restriction of 1.5- 2.5 millibars.

4. An air filter for an internal combustion engine according to claim 2, wherein said filter media has an internal filtering efficiency greater than 98%, cumulative filtering efficiency grater than 99%, and filtered particle SAE coarse dust holding capacity greater than 400 grams per square meter.

5. An air filter for an internal combustion engine according to claim 2, further comprising a second layer of filter media comprising an electrostatically charged material.

6. An air filter for an internal combustion engine according to claim 2, further comprising a second layer microfiber barrier disposed against the downstream air exiting surface.

7. An air filter for an internal combustion engine according to claim 2, further comprising a hexagonal shaped mesh material disposed on at least one surface of said filter media.

8. An air filter for an internal combustion engine according to claim 2, wherein said filter media exhibits a linear gradient density profile.

9. An air filter for an internal combustion engine according to claim 2, wherein said filter media exhibits non-linear gradient density profile.

10. An air filter for an internal combustion engine according to claim 2, wherein the filter media is formed in a generally tubular shape, further comprising an endcap sealing off one end of the filter media.
